(19) United States
(12) Patent Application Publication
(10) Pub. No.: US 2011/0186453 A1
(43) Pub. Date: Aug. 4, 2011

(54) METHOD OF CLEANING A HOUSEHOLD SURFACE

(75) Inventors: John T. Crowe, Southborough, MA (US); Ying Cai, Shrewsbury, MA (US); Paul Krupa, Lake Luzerne, NY (US)

(73) Assignees: SAINT-GOBAIN ABRASIVES, INC., Worcester, MA (US); SAINT-GOBAIN ABRASIFS, Conflans-Sainte-Honorine (FR)

(21) Appl. No.: 12/980,127

(22) Filed: Dec. 28, 2010

Related U.S. Application Data
(60) Provisional application No. 61/290,706, filed on Dec. 29, 2009.

(51) Int. Cl. B08B 1/00; B65D 69/00

(52) U.S. Cl. 206/232; 134/6

(57) ABSTRACT

A method of cleaning a household kitchen or bath solid surface includes placing a cleaning article on the solid surface that includes a foreign matter. The method further includes abrading the solid surface with the cleaning article to remove the foreign matter. The cleaning article includes a layer of a liquid silicone rubber formulation and abrasive grains.

### FIELD OF THE DISCLOSURE

This disclosure, in general, relates to a method of cleaning a household surface.

### BACKGROUND

In a typical household, kitchen and bath surfaces are cleaned on a regular basis. With constant use, kitchen and bath surfaces are dirtied with food, grime, grease, and contaminants. Typically, sponges, cloths, solvents, and abrasive pads are used to remove any unsanitary material on the kitchen and bath surface. Sponges are typically made of cellulose materials. As such, sponges do not have the abrasive qualities to remove hard-stuck contaminants. Abrasive pads may then be used to remove contaminants. Typical materials used for abrasive pads include webbed and woven polymeric and/or metallic strands. For instance, steel wool is commonly used. Although these abrasive pads effectively remove hard-stuck contaminants, they can leave deep scratches and damage the surface that is cleaned.

Furthermore, commercially marketed sponges and abrasive pads suffer from a number of other drawbacks. After a few uses, sponges and abrasive pads tend to become visibly degraded, non-uniform, and soiled, presenting an unsightly appearance even though the product may still have a significant number of uses remaining. Additionally, many commercial sponges and abrasive pads trap in foreign contaminants after use, which can spread particles of grease and grime to previously unsoiled areas.

Moreover, many commercial sponges and abrasive pads are configured as a generally thick block that is stiff such that it does not conform readily to some three-dimensional surfaces. Due to the thickness and stiffness of the sponges and abrasive pads, attempts to clean hard to reach areas may result in excessive scrubbing pressure applied to the surfaces and relatively little cleaning of the region.

As such, an improved method of cleaning a household surface would be desirable.

### SUMMARY

In a particular embodiment, a method of cleaning a household kitchen or bath solid surface includes placing a cleaning article on the solid surface that includes a foreign matter, the solid surface being a kitchen surface or bath surface. The cleaning article includes a layer of a liquid silicone rubber formulation and abrasive grains. The method further includes abrading the solid surface with the cleaning article to remove the foreign matter.

In another embodiment, a merchandised article includes an cleaning article including a layer of a liquid silicone rubber formulation and abrasive grains, a packaging coupled to the cleaning article, the packaging providing a sales message associated with the cleaning article, and a printed instruction included with the packaging, the printed instruction directing a user how to utilize the cleaning article on a solid surface.

### BRIEF DESCRIPTION OF THE DRAWINGS

The present disclosure may be better understood, and its numerous features and advantages made apparent to those skilled in the art by referencing the accompanying drawings.

FIG. 1 includes an illustration of a cross-sectional view of an exemplary structured cleaning article.

FIG. 2 includes a diagram illustrating an exemplary merchandised article including a cleaning article.

The use of the same reference symbols in different drawings indicates similar or identical items.

### DESCRIPTION OF THE EMBODIMENTS

In the specification and in the claims, the terms “including” and “comprising” are open-ended terms and should be interpreted to mean “including, but not limited to . . . . ” These terms encompass the more restrictive terms “consisting essentially of” and “consisting of.”

In a particular embodiment, a method of cleaning a household kitchen or bath surface is disclosed. The method includes a cleaning article that is used to clean a household kitchen or bath solid surface. The cleaning article includes a layer of a liquid silicone rubber formulation and abrasive grains. The cleaning article is placed on the solid surface that includes a foreign matter and the solid surface is abraded with the cleaning article. The cleaning article removes the foreign matter from the household kitchen and bath surface to provide a clean surface that is visibly free of the foreign matter.

In an embodiment, the household and bath solid surface may be any reasonable solid surface material that can be found in a household kitchen or bath. Any reasonable household kitchen or bath surface may be envisioned. For instance, the solid surface may be an inorganic solid surface. Inorganic solid surfaces include, for example, metal surfaces, ceramic surfaces, and the like. Exemplary metals include iron, aluminum, copper, silver, or alloys thereof. Alloys include, for example, stainless steel, brass and copper. Other metals include, for example, gold and alloys thereof. Ceramic surfaces include any reasonable ceramic such as, for example, vitreous-ceramics, crystalline ceramics, glass-ceramics, amorphous ceramics, and the like. In an embodiment, crystalline ceramics include natural stones such as, granite, quartz, and the like. Typical kitchen or bath surfaces include, for example, countertops, appliances, cooking and baking pots and pans, utensils, faucets, tiles, sinks, stove tops and cook tops, grills, handles, showerheads, whitewares such as bathtubs and toilets, and the like. In an embodiment, whitewares and other reasonable surfaces may or may not include an outer glaze amorphous protective layer.

An exemplary method of cleaning household kitchen and bath surfaces is provided. In one particular embodiment, a cleaning article is used to facilitate the cleaning of the household surfaces. The method includes placing the cleaning article on the solid surface that includes foreign matter. In one exemplary embodiment, the cleaning article includes a layer of a liquid silicone rubber formulation and abrasive grains. In an embodiment, the foreign matter may be any reasonable matter such as soil, tarnish, grease, grime, food deposits, liquid deposits, mildew, fungus, combinations thereof, and the like that may be found on kitchen and bath surfaces.

The solid surface is abraded with the cleaning article to remove the foreign matter. Abrading the solid surface to remove foreign matter includes wiping, scrubbing, and the like. The solid surface is then provided for subsequent use. In an embodiment, the solid surface may be abraded with or without a solvent. A typical solvent may aid in breaking up the foreign matter to be removed from the solid surface. The solvent may be provided prior to abrading the solid surface, during the abrading of the solid surface, or any combination thereof. Solvents may include water such as tap water, distilled water, deionized water, and combinations thereof. Solvents may further include any reasonable cleansing agent such as detergents and soaps, antibacterial agents, cleaning enzymes, bleaching agents, waxes, lubricants, the like, and combinations thereof. In an embodiment, the solvent includes a chemical cleanser. In an embodiment, the cleaning article is free of any additional chemical cleansers. In an embodiment, the cleaning article includes a cleanser. For instance, the cleanser is incorporated with the cleaning article. In an exemplary embodiment, the cleanser reacts with water.

The cleaning article is formed from an abrasive formulation forming a layer of surface features. In an embodiment, the cleaning article is backless (i.e., free of a structural backing layer), such that the article is self-supporting. Particularly, the formulation forming the layer of surface features is self-supporting, such that the layer withstands use without structural degradation before the abrasive properties are consumed. The abrasive feature layer includes an assembly of surface protrusions. The assembly of surface protrusions may be random, and in one embodiment, forms a pattern. In addition, the cross-section surface area may vary (generally, increase) during wear of the article, such as in the case of a sloping-sidewall surface protrusion (pyramidal, conical, prismatic, etc. surface protrusions), or may have generally constant cross-sectional surface area during wear, such as in the case of vertical-walled protrusions (rectangular, square, rod, etc. protrusions). In an exemplary embodiment, the cleaning article may also include an adhesion layer.

In an exemplary embodiment, the cleaning article includes an abrasive feature layer formed from a silicone resin and abrasive grains. For example, the silicone resin may be formed from a high consistency silicone rubber (HCR) or a liquid silicone rubber (LSR). In an embodiment, the high consistency silicone rubber (HCR) or liquid silicone rubber (LSR) can further include a reinforcing particulate. In a particular example, the silicone resin is formed from an LSR. In general, the silicone rubber, such as the LSR or HCR, crosslinks to form the silicone resin, which forms a matrix in which the abrasive grains may be distributed or dispersed. Such a crosslinked silicone resin serves as a binder for the abrasive grains and is to be contrasted with uncrosslinked silicones that are configured to migrate to the surface of a cleaning article.

The silicone resin may also be formed from silicone oils, which are generally obtained free of fumed silica. In an exemplary embodiment, the silicone oils, parts A and B, are blended with a catalyst, reinforcing particulate, such as fumed silica, and abrasive grains, and subsequently cured to form the silicone resin product. In a particular embodiment, the silicone resin is a liquid silicone rubber where parts A and B are blended with a catalyst, reinforcing particulate, such as fumed silica, and abrasive grains, and subsequently cured to form the silicone resin product.

An exemplary silicone oil or silicone rubber includes a siloxane polymeric backbone to which functional groups may be attached. In an example, a functional group may include an un-reactive functional group such as a halogen group, a phenyl group, or an alkyl group, or any combination thereof. For example, a fluorosilicone may include a fluorine functional group attached to the backbone. In another exemplary embodiment, the siloxane backbone may be attached to a methyl, an ethyl, a propyl group, or any combination thereof. In addition, the siloxane backbone may include reactive functional groups that function to encourage crosslinking. An exemplary reactive functional group includes a hydride group, a hydroxyl group, a vinyl group, or any combination thereof. For example, the siloxane polymer may include a polyfluorosiloxane, a polyphenylsiloxane, a polyalkylsiloxane, or any combination thereof, which have a reactive functional group, such as a vinyl termination. In a particular example, the silicone resin is formed from a base polysiloxane and a cross-linking agent. The base polysiloxane may be a polyalkylsiloxane such as silicone polymers formed of a precursor, such as dimethylsiloxane, diethylsiloxane, dipropylsiloxane, methylethylsiloxane, methylpropylsiloxane, or combinations thereof. In a particular embodiment, the polyalkylsiloxane includes a polydialkylsiloxane, such as polydimethylsiloxane (PDMS). For instance, the silicone resin is a liquid silicone rubber (LSR) wherein the first part includes a vinyl terminated or grafted polyalkylsiloxane.

In an example, the silicone resin, such as the liquid silicone rubber, further includes a cross-linking agent. In an embodiment, the cross-linking agent may be an organic cross-linking agent. In a particular example, the cross-linking agent is a silicone based cross-linking agent including reactive hydride functional groups. For instance, the crosslinking agent may include a siloxane-based crosslinking agent, having a siloxane backbone attached to reactive functional groups, such as hydride or hydroxyl groups. In a particular embodiment, the crosslinking agent may be polyhydroalkylsiloxane. In an embodiment, the silicone resin is the liquid silicone rubber wherein the second part includes the crosslinking agent.

In a particular embodiment, the abrasive feature layer may be formed from an uncured formulation including a liquid silicone rubber (LSR). For example, the uncured liquid silicone rubber may have a viscosity not greater than about 600,000 cps when measured using test method DIN 53 019 at a shear rate of about 10s⁻¹ and a temperature of about 21° C. For example, the viscosity may be not greater than about 450,000 cps, such as not greater than about 400,000 cps. Typically, the viscosity is at least about 50,000 cps, such as at least about 100,000 cps. In a further example, the viscosity of silicone oil absent reinforcing particulate may be about 5 cps to about 165,000 cps.

In the case of cured formulations, various curing agents, catalysts, and thermal or photoinitiators and sensitizers may be added to the silicone resin prior to curing. In one example, the formulation may be cured using a peroxide catalyst. In another example, the formulation may be cured using a platinum catalyst. In an embodiment, the catalyst may be combination of a peroxide catalyst and a platinum catalyst. In a particular example, the first part of a liquid silicone rubber further includes the catalyst and an inhibitor. For instance, the silicone resin includes a platinum catalyzed two-part liquid silicone rubber (LSR) wherein part A includes a vinyl terminated or grafted polyalkyl siloxane, a catalyst and an inhibitor and part B includes a silicone based cross-linking agent including reactive hydride functional groups.

A silicone matrix formed of the cured silicone resin may exhibit desirable mechanical properties, such that a cleaning article formed from such a silicone resin is self-supporting, enabling formation of a backless cleaning article. In particular, the silicone resin may be used to form the cleaning article that withstands use without structural degradation before the abrasive properties are consumed. For example, the silicone matrix, absent the abrasive grains, may exhibit desirable elongation-at-break, tensile strength, or tensile modulus. For example, the silicone matrix, absent the abrasive grains, may exhibit an elongation-at break of at least about 50%, such as at least about 100%, at least about 200%, at least about 300%, at least about 350%, at least about 450%, or even at least about 500%, as determined using DIN 53 504 S1. In an embodiment, absent abrasive grains, the silicone resin with the reinforcing silica filler may have an elongation-at-break of at least about 350%, such as at least about 450% or even, at least about 500% as determined using DIN 53 504 μl. In another example, the cured silicone resin absent the abrasive grains may have a tensile strength of at least about 10 MPa.

The formulation further includes abrasive grains. In the case of cured formulations, the silicone resin may be blended with abrasive grains prior to curing. Typically, the abrasive grains are blended to form a homogeneous mixture of the abrasive grains throughout the silicone resin. The abrasive grains may be formed of any one of or a combination of abrasive grains, including silica, alumina (fused or sintered), zirconia, zirconia/alumina oxides, silicon carbide, garnet, diamond, cubic boron nitride, silicon nitride, ceria, titanium dioxide, titanium diboride, boron carbide, tin oxide, tungsten carbide, titanium carbide, iron oxide, chromia, flint, emery, or any combination thereof. For example, the abrasive grains may be selected from a group consisting of silica, alumina, zirconia, silicon carbide, silicon nitride, boron nitride, garnet, diamond, co-fused alumina zirconia, ceria, titanium diboride, boron carbide, flint, emery, alumina nitride, or a blend thereof. In particular, the abrasive grains may be selected from the group consisting of nitrides, oxides, carbides, or any combination thereof. In an example, the nitride may be selected from the group consisting of cubic boron nitride, silicon nitride, or any combination thereof. In another example, the oxide may be selected from the group consisting of silica, alumina, zirconia, zirconia/alumina oxides, ceria, titanium dioxide, tin oxide, iron oxide, chromia, or any combination thereof. In a further example, the carbide may be selected from the group consisting of silicon carbide, boron carbide, tungsten carbide, titanium carbide, or any combination thereof, and in particular may include silicone carbide. Particular embodiments use dense abrasive grains comprised principally of alpha-alumina. In another particular example, the abrasive grains include silicone carbide.

The abrasive grain may also have a particular shape. An example of such a shape includes a rod, a triangle, a pyramid, a cone, a solid sphere, a hollow sphere, or the like. Alternatively, the abrasive grain may be randomly shaped.

The abrasive grains generally have an average grain size not greater than 2000 microns, such as not greater than about 1500 microns. In another example, the abrasive grain size is not greater than about 750 microns, such as not greater than about 350 microns. For example, the abrasive grain size may be at least 0.1 microns, such as about 0.1 microns to about 1500 microns, and more typically about 0.1 microns to about 200 microns or about 1 micron to about 100 microns. The grain size of the abrasive grains is typically specified to be the longest dimension of the abrasive grain. Generally, there is a range distribution of grain sizes. In some instances, the grain size distribution is tightly controlled. In an embodiment, the abrasive grains further include aggregates of the abrasive grains. Typically, the type of abrasive grain and the size of the abrasive grain may be chosen depending upon the surface that is to be cleaned.

In an exemplary formulation, the abrasive grains provide about 10% to about 90%, such as from about 30% to about 80%, of the total weight of the formulation. In an exemplary embodiment, the formulation includes at least about 30 wt % of the abrasive grains based on the total weight of the formulation. For example, the formulation may include at least about 45 wt % of the abrasive grains, such as at least about 55 wt % of the abrasive grains. In general, the formulation includes not greater than 90 wt % of the abrasive grains, such as not greater than 85 wt % of the abrasive grains.

In an exemplary embodiment, the formulation forming the cleaning article may include a reinforcing particulate. In the case of cured formulations, the optional reinforcing particulate is typically added prior to curing. Typically, the reinforcing particulate is blended to form a homogeneous mixture of the reinforcing particulate throughout the silicone resin. For example, the reinforcing particulate may be incorporated in the silicone resin. Alternatively, the reinforcing particulate may be added to the silicone oil in conjunction with preparing the formulation, such as just prior to adding the abrasive grains. An exemplary reinforcing particulate includes a silica particulate, an alumina particulate, or any combination thereof. In a particular example, the reinforcing particulate includes silica, such as fumed silica. An exemplary silica particulate is available from Degussa under the trade name Aerosil, such as Aerosil R812S, or available from Cabot Corporation, such as Cabosil M5 fumed silica. In another exemplary embodiment, the reinforcing silica may be incorporated into a liquid silicone rubber formulation, such as Elastosil 3003 formulations available from Wacker Silicones. In an embodiment, the reinforcing particulate is typically dispersed within the silicone matrix, and is typically mono-dispersed, being substantially agglomerate free. In another embodiment, the reinforcing particulate is dispersed within the silicone matrix as aggregates and agglomerates.

In another exemplary embodiment, reinforcing particulate formed via solution-based processes, such as sol-formed and sol-gel formed ceramics, are particularly well suited for use in the formulation. Suitable sols are commercially available. For example, colloidal silicas in aqueous solutions are commercially available under such trade designations as “LUDOX” (E.I. DuPont de Nemours and Co., Inc. Wilmington, Del.), “NYACOL” (Nyacol Co., Ashland, Ma.) or “NALCO” (Nalco Chemical Co., Oak Brook, Ill.). Many commercially available sols are basic, being stabilized by alkali, such as sodium hydroxide, potassium hydroxide, or ammonium hydroxide. Additional examples of suitable colloidal silicas are described in U.S. Pat. No. 5,126,394, incorporated herein by reference. Especially well-suited are sol-formed silica and sol-formed alumina. The sols can be functionalized by reacting one or more appropriate surface-treatment agents with the inorganic oxide substrate particles in the sol.

In a particular embodiment, the reinforcing particulate is sub-micron sized. The reinforcing particulate may have a surface area in a range of about 50 m²/g to about 500 m²/g, such as within a range of about 100 m²/g to about 400 m²/g. The reinforcing particulate may be a nano-sized particulate, such as a particulate having an average particle size of about 3 nm to about 500 nm. In an exemplary embodiment, the reinforcing particulate has an average particle size of about 3 nm to about 200 nm, such as about 3 nm to about 100 nm, about 3 nm to about 50 nm, about 8 nm to about 30 nm, or about 10 nm to about 25 nm. In particular embodiments, the average particle size is not greater than about 500 nm, such as not greater than about 200 nm, or not greater than about 150 nm. For the reinforcing particulate, the average particle size may be defined as the particle size corresponding to the peak volume fraction in a small-angle neutron scattering (SANS) distribution curve or the particle size corresponding to 0.5 cumulative volume fraction of the SANS distribution curve.

The reinforcing particulate may also be characterized by a narrow distribution curve having a half-width not greater than about 2.0 times the average particle size. For example, the half-width may be not greater than about 1.5 or not greater than about 1.0. The half-width of the distribution is the width of the distribution curve at half its maximum height, such as half of the particle fraction at the distribution curve peak. In a particular embodiment, the particle size distribution curve is mono-modal. In an alternative embodiment, the particle size distribution is bi-modal or has more than one peak in the particle size distribution.

In an example, the reinforcing particulate is included in the formulation in an amount based on the combined weight of the silicone, the reinforcing particulate, and the abrasive grains. For example, the reinforcing particulate may be included in the formulation in an amount of at least about 3 wt % based on the total weight of the formulation, including reinforcing particulate, silicone resin, and abrasive grains. In particular, the formulation may include at least about 5 wt % of the reinforcing particulate or particulate, such as at least about 10 wt % of the reinforcing particulate, or even at least about 13 wt % of the reinforcing particulate. Further, the formulation may include not greater than about 60 wt % of the reinforcing particulate, such as not greater than about 50 wt % of the reinforcing particulate.

Generally, the formulation, including the silicone resin, the abrasive grains, and optional reinforcing particulate, forms the abrasive feature layer of the cleaning article. The type of abrasive grains and any optional reinforcing particulate may be chosen depending upon the material and the foreign matter that will be removed. In some embodiments, the cleaning article consists essentially of the liquid silicone rubber and abrasive grains described above. As used herein, the phrase “consists essentially of” used in connection with the cleaning article precludes the presence of polymers that affect the basic and novel characteristics of the cleaning article, although, various curing agents, catalysts, and thermal or photoinitiators, sensitizers, and reinforcing particulates may be used in the abrasive article.

Once formed into a layer, the formulation exhibits mechanical properties that advantageously enhance the performance of the cleaning article formed of the formulation. In particular, the formulation may exhibit desirable mechanical properties, such as elongation-at-break, hardness, tensile modulus, or tensile strength. In addition, the cleaning article may be evaluated for performance in producing surface characteristics desirable in a cleaned product.

In an exemplary embodiment, the formulation exhibits an elongation-at-break of at least about 50%, for example, measured using test method ASTMD 412 or test method DIN 53 504 S 1. In particular, the elongation-at-break may be at least about 100%, such as at least about 125%, or even at least about 135%.

The cured formulation may also have a desirable hardness, such as a hardness in a range of about 50 shore A to about 75 shore D based on testing method DIN53 505. For example, the hardness may be not greater than about 75 shore D, such as not greater than about 60 shore D, or not greater than about 50 shore D. The hardness of the cured formulation indicates a flexible material.

In another exemplary embodiment, the formulation exhibits a desirable tensile modulus of not greater than about 8.0 MPa at 100% strain based on ASTM D 412. For example, the tensile modulus may be not greater than about 7.6 MPa, such as not greater than about 7.5 MPa. In addition, the cured formulation may have a desirable tensile strength of at least about 7.0 MPa based on ASTM D 412. For example, the cured formulation may have a tensile strength of at least about 7.5 MPa, such as at least about 8.0 MPa. Alternatively, the formulation may exhibit a tensile modulus of at least about 8 MPa, such as at least about 14 MPa, or even at least about 30 MPa. Particular formulations may exhibit a tensile modulus of greater than 100 MPa.

The mechanical properties of the formulation may contribute to the performance of the cleaning article, such as advantageously contributing to surface characteristics achievable by a cleaning article formed from such a formulation. For example, the mechanical properties of the cured formulation may contribute to surface performance characteristics. Further, the cleaning article may exhibit desirable material removal rates.

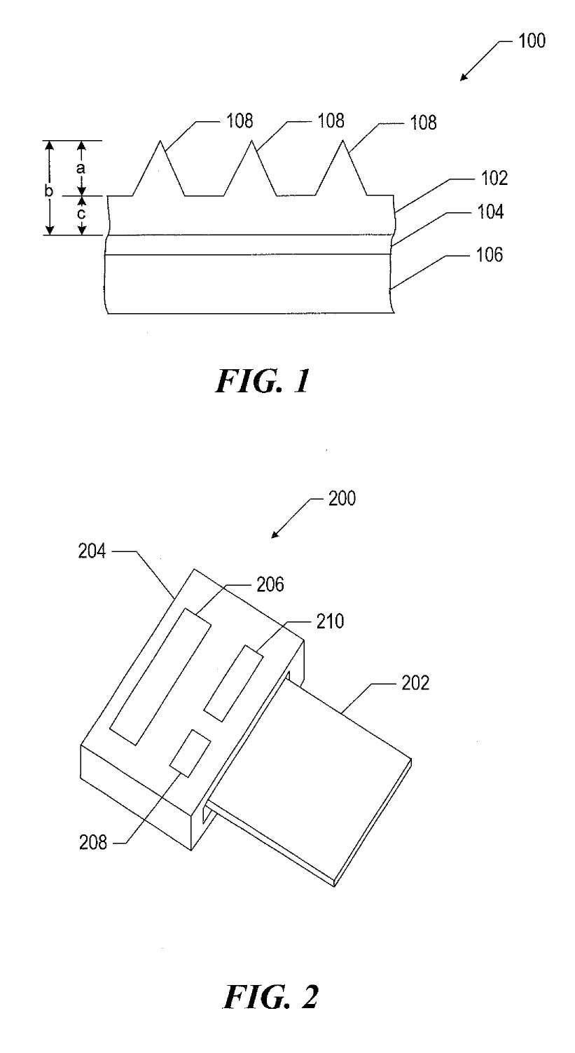

In an exemplary embodiment, the formulation forms the abrasive feature layer of a cleaning article. FIG. 1 includes an illustration of an exemplary structured cleaning article 100. Alternatively, the formulation may be used in forming other non-structured coated cleaning articles or bonded cleaning articles. Typically, a structured coated cleaning article includes a coated cleaning article having an assembly of protruding surface structures, typically arranged in a pattern.

The structured cleaning article, also called an engineered abrasive article, contains a plurality of abrasive grains dispersed in a binder and formed into discrete three-dimensional units either in a pattern or a random array on or throughout the cleaning article. Structure cleaning articles typically have a relatively high material removal rate in combination with a fine surface finish and long life. These articles are designed to wear away, continually exposing fresh abrasive to the grinding interface. However, most structured cleaning articles are designed for high force applications. Thus, when used in low force applications, the resinous silicone binder does not break down or wear away to expose new abrasive grains.

The exemplary cleaning article 100 illustrated in FIG. 1 includes an abrasive feature layer 102. The abrasive feature layer 102 includes protruding structures 108, which may be arranged in a pattern. In the illustrated embodiment, the protruding structures 108 are configured to provide increasing contact area in response to wear, as in the case of protrusions with sloping side surfaces. For example, the structures 108 may have a cross-section that decreases with increased distance from the base of the abrasive feature layer 102. Typically, the abrasive feature layer 102 is formed from the formulation that includes the liquid silicone rubber formulation, abrasive grains, and optional reinforcing particulate. In particular, the abrasive grains are dispersed throughout the thickness of the abrasive feature layer 102. In an embodiment, the abrasive feature layer is self-sharpening. “Self-sharpening” as used herein refers to the abrasive feature layer 102 maintaining its abrasive qualities as the cleaning article is used and as the thickness of the abrasive feature layer 102 is decreased during wear. In an embodiment, the formulation may be formed into a patterned layer and cured or set to produce the abrasive feature layer 102 having structures 108.

In an exemplary embodiment, the abrasive feature layer 102 may be formed with a backing or support layer. The backing is typically directly bonded to and directly contacts the abrasive feature layer 102. For example, the abrasive feature layer 102 may be extruded onto or calendered onto a backing. The backing or support may include a polymer film, a polymer foam, or a fibrous fabric. In a particular example, the backing or support may include cloth, paper, or any combination thereof. Typically, the backing or support layer is a non-abrasive layer that does not include abrasive grains. In an embodiment, the backing or support layer generally provides additional structural support or imparts mechanical properties to the cleaning article without which the abrasive feature layer 102 would not perform as well.

Alternatively, the cleaning article 100 may be free of a backing layer. Particular formulations used to form the abrasive feature layer 102 provide desirable mechanical properties and can be self-supporting. That is, the abrasive feature layer 102 can be configured to not have reliance on a backing layer in use or during manufacture. For example, a self-supporting abrasive feature layer 102 may withstand use without structural degradation prior to the abrasive properties being consumed. In particular, the properties of the polymer in the formulation may permit formation of the cleaning article 100 without a backing layer, which may have particular advantages over the state of the art that generally requires use of a backing to carry the abrasive feature layer through the coating process and to provide mechanical integrity or flexibility during use. In particular, the abrasive feature layer 102 may be self-supporting without the presence of an underlying support or backing layer. Such underlying support or backing layers traditionally have tensile properties, such a combination of strength and flexibility, that are superior to those of traditional abrasive layers. In this particular embodiment, the cleaning article 100 is free of a layer having tensile properties superior to the tensile properties of the abrasive feature layer 102.

In addition to the abrasive feature layer 102, the cleaning article 100 may include an adhesion layer 104. In an embodiment, the adhesion layer 104 may include a pressure sensitive adhesive or a cured adhesive. When the adhesive is used to bond the cleaning article to a cleaning tool, a release film may cover the abrasive feature layer to prevent premature adhesion. Such release films are typically removed just prior to attachment of cleaning article 100 to a cleaning tool. In an embodiment, an adhesion layer may form an underside surface (not shown), such as a pressure sensitive adhesive surface, and the abrasive feature layer may have surface features that form the abrasive upper surface. In particular, the adhesion layer is in direct contact, such as without intervening structural layers, with the abrasive feature layer.

In another exemplary embodiment, the adhesive feature layer 102 may bond to a fastener sheet 106. For example, the fastener sheet 106 may be one component of a hook and loop fastening system. Such a fastening system may be used to couple the cleaning article 100 to a cleaning tool.

The structures 108 of the cleaning article 100 may be arranged in a pattern. For example, the abrasive structures may be arranged in a grid pattern. In another exemplary embodiment, abrasive structures may be arranged in parallel lines. Alternatively, the structures may be arranged randomly with no defined pattern, or elements may be offset from one another in alternating rows or columns. In an additional example, the structures may be discrete protrusions having sloped side walls. In another example, the structures may be discrete protrusions having substantially vertical side walls. The structures may be arranged in an array having a pattern or may be arranged in a random array.

In one embodiment, the abrasive structures protruding from the abrasive feature layer are configured to increase in contact area in response to wear. For example, the abrasive structure may have a triangular cross-section. With a first degree of wear, the contact area is less than the contact area resulting from additional wear. Typically with decreasing vertical height, the contact area generally formed in a horizontal plane increases. In another exemplary embodiment, the structure may have a semicircular cross-section. The structures or protrusions may have a vertical cross-section that is regularly shaped or irregularly shaped. If regularly shaped, the protrusions may have a horizontal cross-section, such as a circle or a polygon.

Returning to FIG. 1, the formulation described above has been found to be particularly useful in forming particular structured cleaning articles, especially those without a support or backing layer, and including thin structures. In an exemplary embodiment, the abrasive feature layer 102 has a total height as denoted by letter “b” not greater than about 500 mils, such as not greater than about 350 mils, not greater than about 200 mils, not greater than about 100 mils, not greater than about 50 mils, or even not greater than about 35 mils. The abrasive structures 108, as denoted by letter “a”, may be not greater than about 20 mils, such as not greater than about 15 mils. Further, the thickness of the abrasive feature layer 102 not including the abrasive structures 108, as denoted by letter “c” may be not greater than about 15 mils, such as not greater than about 10 mils.

The cleaning article 100 may be cut and shaped to any reasonable size depending on the use. For instance, the cleaning article may be shaped as a square, a rectangle, a circle, an oval, a triangle, a cylinder, or any other reasonable shape. Further, the cleaning article may be shaped to fit a hand or any reasonable cleaning tool. Further, the cleaning article 100 has flexibility, which is desirable to clean intricate shapes and contoured surfaces. For instance, the hardness of the cleaning article is in a range of about 50 shore A to about 75 shore D based on testing method DIN53 505. For example, the hardness may be not greater than about 75 shore D, such as not greater than about 60 shore D, or not greater than about 50 shore D.

In one exemplary embodiment, the cleaning article is included in a merchandised article for commercial sale. FIG. 2 illustrates a merchandised article 200 including a cleaning article 202 and packaging 204. The packaging 204 is connected to the cleaning article 202. The packaging 204 may include a sales message, title or description of the cleaning article 206 and a barcode 208 or other indicator of sales price or facilitator of a sales transaction.

In addition, the merchandised article 200 may include a set of printed instructions 210. The printed instructions 210 may be printed on the packaging 204 or included as a separate sheet with the packaging 204 and cleaning article 202. In one exemplary embodiment, the instructions direct a user to place the cleaning article 202 on a solid surface. In another exemplary embodiment, the instructions 210 direct a user to clean a solid surface with the cleaning article. In another exemplary embodiment, the instructions 210 direct a user to clean the solid surface with the cleaning article to remove foreign matter on the solid surface.

While embodiments of the cleaning article are useful in residential applications, other surfaces that may be cleaned include, for example, any other reasonable household surfaces. Other surfaces include, for example, wood surfaces, polymer surfaces, acrylic surfaces, polyester surfaces, laminates, and the like. Further included surfaces may be natural gemstones, ornamental surfaces, and the like. Additionally, particular embodiments of the cleaning article have advantageous use in commercial applications. Exemplary commercial applications include the medical field, the dental field, the pharmaceutical industry, the transportations industry, the food industry such as in commercial kitchens and for use in food transfer and storage, for sporting goods and equipment, and the like. For instance, any reasonable tools and surfaces for the above-mentioned applications may be cleaned with the cleaning article.

Particular embodiments of the cleaning article advantageously provide improved surface characteristics when used. For example, use of particular embodiments of the cleaning article may exhibit improvements in roughness and gloss in abraded surfaces. In an exemplary embodiment, the cleaning article cleans a solid surface without leaving deep scratches or surface defects that remain on the surface. In a particular embodiment, such cleaning articles are useful in instances where no subsequent coating process is used and abrading with the cleaning article may impart dirt or dust resistance to the polished surface.

Further, the cleaning article may be easily cleaned and reused. In a particular embodiment, the cleaning article is cleaned of any remaining foreign matter with water. In an exemplary embodiment, the cleaning article does not retain foreign matter within its structure and thus, does not spread foreign matter to other surfaces. Further, the cleaning article is reusable, i.e. may be reused a multiple number of times without degrading and losing its efficiency as a cleaning article. For instance, the cleaning article can be used at least about 3 to about 5 times, such as at least about 10 times, or even at least about 20 times without visible degradation of the cleaning article. Typically, the level of degradation of the cleaning article is dependent upon the foreign matter and the surface being cleaned.

Further details of the construction of the cleaning article may be found in US Patent Application Publication No. US 2008/0014840A1 (US '840), incorporated herein by reference. It is noted that the US '840 is generally directed to abrasive structures utilized in the context of automotive paint repair, not in the context of cleaning articles, and methods of cleaning household surfaces incorporating same.

### EXAMPLES

A LSR J800 pad obtained from Saint-Gobain is used as a cleaning cloth on multiple steel kitchen utensils. Utensils and pad are moistened and rinsed with tap water before and between polishing. All the surfaces are previously polished with 3M Scotch-Brite® pads, which are not able to remove the surface contamination from cooking.

A heavily charred stainless steel heating element casing of a soymilk maker is cleaned with a wet LSR pad. Upon visual inspection, the stainless steel element is clean and free of any foreign matter.

A heavily charred cast iron pot is cleaned with a wet LSR pad. Upon visual inspection, the cast iron pot is clean and free of any foreign matter.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

1. A method of cleaning a household kitchen or bath solid surface comprising:
placing a cleaning article on the solid surface that includes a foreign matter, the solid surface being a kitchen surface or bath surface, the cleaning article comprising a layer of a liquid silicone rubber formulation and abrasive grains; and
abrading the solid surface with the cleaning article to remove the foreign matter.

2. The method of claim 1, wherein the solid surface includes a metal.

3. (canceled)

4. The method of claim 1, wherein the solid surface includes a ceramic.

5. The method of claim 1, wherein the foreign matter includes soil, tarnish, grease, food deposits, liquid deposits, or combination thereof.

6. The method of claim 1, wherein the liquid silicone rubber is formed of a two-part silicone rubber, wherein one part includes a crosslinking agent.

7. The method of claim 1, wherein the cleaning article includes at least about 30 wt % of the abrasive grains based on the total weight of the formulation.

8. The method of claim 1, wherein the abrasive grains is selected from a group consisting of nitrides, carbides, oxides, and a blend thereof.

9. (canceled)

10. (canceled)

11. (canceled)

12. (canceled)

13. (canceled)

14. (canceled)

15. (canceled)

16. The method of claim 1, wherein the abrasive grains is selected from a group consisting of silica, alumina, zirconia, zirconia/alumina oxides, silicon carbide, garnet, diamond, cubic boron nitride, silicon nitride, ceria, titanium dioxide, titanium diboride, boron carbide, tin oxide, tungsten carbide, titanium carbide, iron oxide, chromia, flint, emery, and any combination thereof.

17. (canceled)

18. The method of claim 1, wherein the cleaning article further includes a reinforcing particulate.

19. (canceled)

20. (canceled)

21. (canceled)

22. (canceled)

23. (canceled)

24. The method of claim 1, wherein the cleaning article includes a major surface having a set of protrusions.

25. (canceled)

26. (canceled)

27. (canceled)

28. (canceled)

29. The method of claim 1, further comprising providing a solvent to the solid surface prior to abrading the solid surface, during the abrading of the solid surface, or combination thereof.

30. (canceled)

31. A merchandised article comprising:
a cleaning article comprising a layer of a liquid silicone rubber formulation and abrasive grains;
a packaging coupled to the cleaning article, the packaging providing a sales message associated with the cleaning article; and
a printed instruction included with the packaging, the printed instruction directing a user to utilize the cleaning article on a solid surface.

32. (canceled)

33. (canceled)

34. The merchandised article of claim 31, wherein the liquid silicone rubber is formed of a two-part silicone rubber, wherein one part includes a crosslinking agent.

35. The merchandised article of claim 31, wherein the cleaning article includes at least about 30 wt % of the abrasive grains based on the total weight of the formulation.

36. The merchandised article of claim 31, wherein the abrasive grains are selected from a group consisting of nitrides, carbides, oxides, and a blend thereof.

37. The merchandised article of claim 31, wherein the abrasive grains is selected from a group consisting of silica, alumina, zirconia, zirconia/alumina oxides, silicon carbide, garnet, diamond, cubic boron nitride, silicon nitride, ceria, titanium dioxide, titanium diboride, boron carbide, tin oxide, tungsten carbide, titanium carbide, iron oxide, chromia, flint, emery, and any combination thereof.

38. The merchandised article of claim 31, wherein the abrasive grains are in the form of aggregates.

39. The merchandised article of claim 31, wherein the cleaning article further includes a reinforcing particulate.

40. (canceled)

41. The merchandised article of claim 39, wherein the reinforcing particulate includes silica.

42. The merchandised article of claim 31, wherein the cleaning article is in the form of an abrasive sheet and wherein the cleaning article is free of a backing layer.

43. The merchandised article of claim 31, wherein the cleaning article is in the form of a sheet having a major surface, wherein the major surface has an assembly of surface protrusions.

44. The merchandised article of claim 43, wherein the assembly of surface protrusions are arranged in a pattern.

45. The merchandised article of claim 43, wherein the surface protrusions are sloping side-wall surface protrusions.

46. The merchandised article of claim 43, wherein the surface protrusions are vertical walled surface protrusions.

47. The merchandised article of claim 31, wherein the cleaning article further includes a cleanser.

48. (canceled)

49. (canceled)
